(19) United States
(12) Patent Application Publication
(10) Pub. No.: US 2012/0095992 A1
(43) Pub. Date: Apr. 19, 2012

(54) UNIFIED MEDIA SEARCH

(76) Inventors: Timothy Cutting, Los Gatos, CA (US); Mike Garcen, Milpitas, CA (US)

(21) Appl. No.: 13/316,355

(22) Filed: Dec. 9, 2011

Related U.S. Application Data
(63) Continuation of application No. 12/398,166, filed on Mar. 4, 2009.
(60) Provisional application No. 61/068,230, filed on Mar. 4, 2008.

(51) Int. Cl. G06F 17/30

(52) U.S. Cl. 707/722; 707/E17.028; 707/E17.014

(57) ABSTRACT

A user input of a search term is received. One or more local resources are searched using the search term. One or more Internet services are searched using the search term. Search results of media located on the local resources that match the search terms and search results of media provided by the Internet services are graphically displayed together in a unified results display.

### RELATED APPLICATIONS

This patent application is a continuation of U.S. Non-Provisional application Ser. No. 12/398,166, filed Mar. 4, 2009, which claims the benefit under 35 U.S.C. §119(e) of U.S. Provisional Application No. 61/068,230, filed Mar. 4, 2008, both of which are herein incorporated by reference.

### FIELD OF THE INVENTION

The present invention relates to home media centers, and more particularly to providing a unified media search capability to home media centers.

### BACKGROUND OF THE INVENTION

Home media centers are used to record television shows, watch movies, surf the web, play music, organize personal photos, and perform other media functions. Conventional home media centers store media in a directory structure. To access a particular desired media file, a user must generally navigate through the directory structure to that media file. For example, if a user wishes to hear a specific song by a particular artist, he must navigate to a music directory, select a subdirectory for that artist, select another subdirectory of an album, and then select the desired song.

Some conventional media centers include a conventional built in search function. However the conventional built-in search function searches a specified directory for the desired media. For example, if a user desires to watch a recorded television show, he must direct the media center to run a search on a keyword within the recorded television show directory. Conventional media centers do not include a unified search capability that can search all types of local media concurrently. Nor do conventional media centers include a unified search capability that can search both local resources and remote resources concurrently.

### BRIEF DESCRIPTION OF THE DRAWINGS

The present invention is illustrated by way of example and not limitation in the figures of the accompanying drawings, in which like references indicate similar elements and in which:

FIG. 1 illustrates an exemplary configuration of a home media center in accordance with one embodiment of the present invention;

FIG. 2 illustrates a flow diagram for a method of searching for digital media data, in accordance with one embodiment of the present invention;

FIGS. 3-12 illustrate exemplary embodiments of a living room user interface in accordance with the present invention; and

FIG. 13 illustrates a diagrammatic representation of a machine in the exemplary form of a computer system.

### DETAILED DESCRIPTION

Described herein are methods and apparatuses for a home media center that provides a unified media search capability. In one embodiment, a home media center receives a user input of a search term. One or more local resources are searched using the search term. One or more Internet services are also searched using the search term. Search results of media located on the local resources that match the search terms and search results of media provided by the Internet services are displayed together in a unified results display.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “searching”, “calculating”, “filtering”, “displaying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

A machine-readable medium may include any mechanism for storing or transmitting information in a form readable by a machine (e.g., a computer). For example, a machine-readable medium includes a machine readable storage medium such as a read only memory (“ROM”), random access memory (“RAM”), magnetic disk storage media, optical storage media, flash memory device, etc.

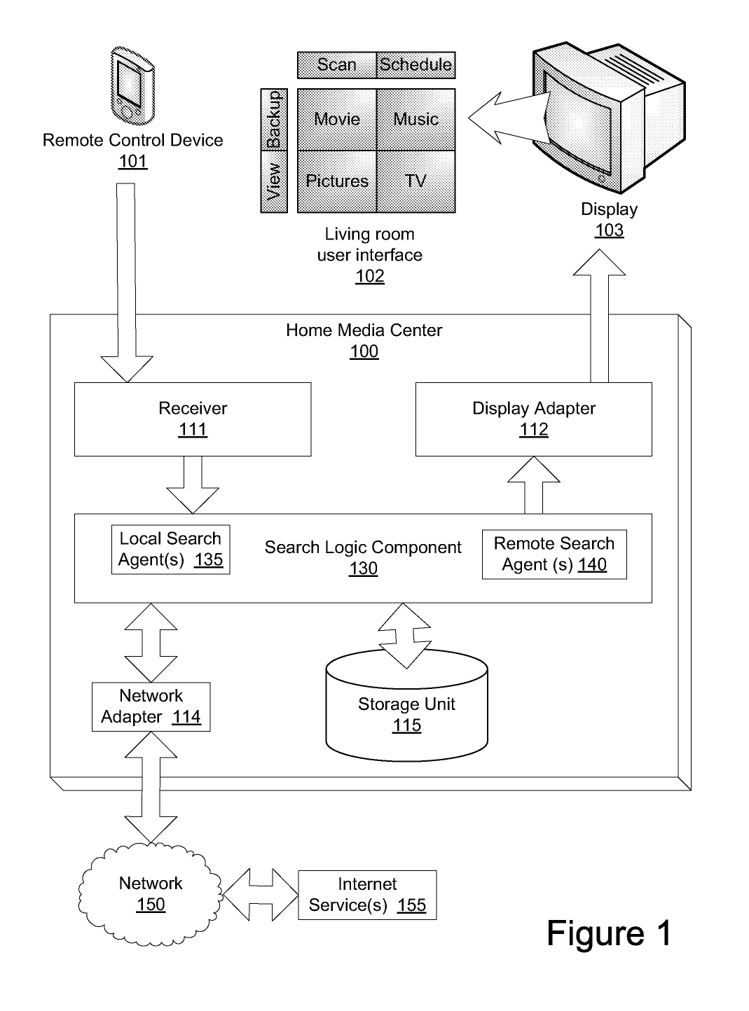

FIG. 1 illustrates a home media center 100, in accordance with one embodiment of the present invention. Home media center 100 may be a set-top box, personal computer, rackmount server, etc. configured to receive, display, record, play, and otherwise manage digital media data. The home media center 100 may include a hardware platform, and an operating system that runs on the hardware platform. The operating system may be a specialized operating system configured for home media use (e.g., Windows® XP Media Center Edition, Tivo® operating system, etc.) or a generic operating system (e.g., Windows® XP, Windows® Vista, Mac® OS X, Linux, etc.). If the operating system is a generic operating system, then one or more home media center applications may run on the operating system, examples of which include MythTV, Boxee, X-Box Media Center (XBMC), etc.

The digital media data may include audio data (e.g., music, audio books, podcasts of radio programs, etc.), video data (e.g., recorded movies, television shows, home movies, etc.), digital still images, electronic documents, spreadsheets, etc. Formats of the digital media data may include, for example, compact disc (CD), video compact disc (VCD), digital video disc (DVD), moving picture experts group (MPEG), MPEG-1 audio layer 3 (MP3), graphics interchange format (GIF), JPG, Quicktime® media format (MOV), personal document format (PDF), Doc, PPT, XLS, DivX, etc.

In one embodiment, the home media center 100 includes a receiver 111, a display adapter 112, a service component logic 130, a network adapter 114 and a storage unit 115. Search logic component 130 may be software (e.g., an application, module, plugin, extension, etc.) or hardware that manages searches of the storage unit 115, internet services 155, and/or other remote resources. Search logic component 130 may also be a combination of hardware and software.

To initiate a search, in one embodiment search logic component 130 generates a living room user interface 102 and transmits the interface 102 to a display 103 via the display adapter 112. Alternatively, search logic component 130 may use an existing living room user interface provided by, for example, an operating system or application that runs on home media center 100. User commands may then be received selecting or inputting search terms to execute a search. In one embodiment, multiple search operations may be placed in a search queue, from which they can be executed concurrently, or sequentially. Search execution is discussed in greater detail below.

Display 103 may be a high definition television, standard television, projector, computer monitor, and so on. Display adapter 112 may connect with the display 103 via an HDMI connection, analog VGA connection, S-Video connection, RCA connection, or other by other digital or analog video connections.

According to an embodiment of the invention, a living room user interface 102 provides a simplified and convenient operational environment for a user to use and manage digital media data. The term “living room user interface” 102 is a convenient label that refers to a user interface that is comfortably viewable from a standard living room environment (e.g., wherein seating is placed 6-12 feet from a display). However, the living room user interface 102 is not restricted to use in a living room, and may include, for example, an interface used in a theater, office, bedroom, or other setting. In one embodiment, the living room user interface 102 is suitable for operating home media center 100 from an arms-length distance to 10 or more feet (depending on a screen size, resolution setting, and visual acuity of a user). In such an environment, a user is not constrained to be immediately in front of a display device (e.g., within 1-2 feet of a display device, such as with a standard computer interface) to perform actions such as backing up digital media data.

A user may browse the living room user interface 102 and invoke operations embedded in the interface 102 by using the remote control device 101. The receiver 111 is configured to receive wireless signals from the remote control device 101, translate the received wireless signals, and transmit the translated messages to the search logic component 130. Receiver 111 may receive infrared (IR) signals, radio frequency (RF) signals, Bluetooth signals, or other signals sent from remote control device 101.

In one embodiment, remote control device 101 is a small wireless handheld device with multiple buttons. Alternatively, the remote control device 101 may include a wireless keyboard, wireless pointer, or other input device. The remote control device 101 may communicate with the home media center 100 via infrared signals, radio frequency (RF) signals, Bluetooth™ protocol messages, etc. The range of the wireless communication from the remote control device 101 to the receiver 111 is dependant on the physical characteristics of the signal implemented. For example, communication range for an infrared signal is about a dozen feet, while communication range for an RF signal may be up to 30 feet or more.

Remote control device 101 provides the user an ability to operate and interact with the home media center 100 from a distance (e.g., by navigating the living room user interface, and invoking displayed menu selections). Remote control device 101 frees the user from being stationary in a pre-defined location (e.g., immediately in front of display 103). As long as the user is within the wireless communication range of the remote control device 101, he may interact with the living room user interface 102 from any position from which he can adequately see the living room user interface 102. Therefore, the user may view and manage (e.g., search) digital media displayed by the home media center 100 from, for example, a sofa, recliner, or other convenient viewing location.

In an alternative embodiment, a 2-foot user interface is displayed on display 103. In such an embodiment, remote control device 101 may be replaced by a keyboard and pointer (e.g., mouse), which may be connected with receiver 111 wirelessly (e.g., using Bluetooth) or via a cable (e.g., usb, PS/2, etc.). A 2-foot user interface is an interface that is viewable from immediately in front of the display 103 (e.g., from up to 2-feet away).

Storage unit 115 stores digital media data used by home media center 100. Digital media data may be stored in and retrieved from the storage unit 115 by the search logic component 130. Storage unit 115 may be a hard drive, array of hard drives, and/or solid state memory (e.g., non-volatile random access memory (NVRAM), Flash, etc.). In one embodiment, the storage unit 115 is a local storage device internal to the home media center 100. In another embodiment, the storage unit 115 includes an external storage device accessible via a network adapter 114 or through other input/output (I/O) peripherals, such as small computer system interface (SCSI), serial ATA (SATA), Firewire, fibre channel, or universal serial bus (USB) ports. In one embodiment, digital media is stored on storage unit 115 in a file system format. Alternatively, the storage unit 115 may be a database such as a relational database.

In one embodiment, the home media center 100 includes a network adapter 114. The network adapter 114 includes input/output ports that are configured to couple via a wired or wireless connection with a network 150 (e.g., a public network such as the internet, or a private network). In one embodiment, home media center 100 may communicate with internet services 155 or other remote resources (e.g., databases) through the network adapter 114 according to standardized protocols, such as transmission control protocol/internet protocol (TCP/IP), IEEE 802.11 (WiFi), SCSI, SATA, Firewire, USB, etc.

In one embodiment, Internet services 155 include media services that are accessible via the Internet. Examples of such services include Flickr®, Netflix®, Sirius® satellite radio, online media stores (e.g., Amazon®, itunes®, Napster®, etc.). Each Internet service may include an application programming interface (API) that is accessible to search logic component 130. Search logic component 130 may use the API of a specific internet service 155 to invoke and to search for media files on the specific Internet service 155 using specified search terms.

In one embodiment, the search logic component 130 receives an input of a search term from the remote control device 101 via receiver 111. The search term may be received, for example, via a triple-tap interface (e.g., an interface where each number is associated with three different letters, as is standard in telephones), based on selection of commonly used search terms displayed to a user, via a keyboard, etc. Once a search term has been selected, search logic component 130 can search storage unit 115 and/or Internet services 155 for media files associated with the search term.

In one embodiment the search logic component 130 includes one or more local search agents 135 and one or more remote search agents 140. Each search agent is a module within the search logic component 130 that is configured to search a specified channel (source) for specified media. Each remote search agent 140 can be configured to use an API (e.g., a simple object access protocol (SOAP) compliant API) of a specific Internet service 155. For example a first remote search agent may be configured to search on Flickr® using Flickr's API, while a second remote search agent may be configured to search on Netflix® using Netflix's API. A local search agent 135 and/or remote search agent 140 may also be configured to search for media on multiple different sources (e.g., on multiple different internet services, on multiple different local sources, and/or on a combination of local sources and internet services). For example, a single remote search agent 140 may be configured to search multiple internet services 155 that use the same or similar APIs. In one embodiment, a remote search agent 140 may access an RSS feed of an Internet service 155.

In one embodiment, the digital media includes metadata that identifies properties of the digital media. For example, an audio file may include metadata that identifies an artist name, song name, album name, track number in album, recording date, etc. In one embodiment, at least some search agents use this metadata to conduct searches. Other search agents may not use metadata of digital media files when conducting searches. For example, a remote search agent 140 may simply supply a search term to an internet service 155 and rely on the internet service 155 to provide results.

If a new internet service becomes available, then a new remote search agent 140 may be added to search logic component 130 for performing searches on the new internet service. Alternatively, an existing remote search agent may be modified to perform searches on the new internet service. Search agents may be implemented as plugins or extensions.

If an Internet service 155 requires a user account, the remote search agent 140 may login to the Internet service 155 using a user's identification (ID) and password. A user may be prompted to enter the user ID and password upon initiating the search. Alternatively, user ID and password may be stored by home media center 100 (e.g., by and account management logic component (not shown)). A separate account (e.g., user ID and password) may be used for each internet service. Therefore, the account management logic component may store multiple accounts, and associate each account with a particular search agent or search agents.

Once a user is initially connected to a specific Internet service 155, home media center 100 may maintain a session with that internet service 155, such as by using cookies. Therefore, the search agent may only need to supply an internet service with login information when a first search is executed. In one embodiment, the home media center 100 logs on to one or more internet services 155 automatically when the home media center 100 is turned on. Therefore, no logins may be necessary when a search is performed.

Each local search agent 135 can be configured to search for media files in specified local locations, or for media files of a specific type. For example a first local search agent may be configured to search storage unit 115 for music files, while a second local search agent may be configured to search storage unit 115 for recorded television files. A local search agent may also be configured, for example, to search for future programming in an electronic programming guide (EPG) stored in storage unit 115.

Search results returned by search agents 140 may include additional functionality that can be attached to the search results (e.g., those obtained from an Internet service 155). For example, search results obtained from an online movie rental service may include controls for adding the search result to a rental queue, while search results obtained from an electronic programming guide (EPG) may include controls for scheduling a future recording, and search results obtained from an online music store may include controls for purchasing a particular song or album and/or adding the song or album to a wish list. Therefore, the search logic component 130 may provide interactive search results. Specific details as to the controls that may be added to search results are dependent upon the Internet services, local services, and/or API used.

In one embodiment search agents are user selectable. Therefore a user may choose which Internet services he wishes to search and/or what local resources (e.g., specific drives, media types, etc.) he wants to search.

Each search agent forwards search results to search logic component 130. Search logic component 130 may then display local search results and remote search results (e.g., those from Internet services 155) together in the living room user interface 102 (or 2-ft user interface). The local search results and remote search results in one embodiment are returned other than as a list of search result names. In a further embodiment, the search results are displayed visually (e.g., via thumbnails, pictures, or other images). For example, a search result for a song may display an album cover along with an icon identifying the result as a song, a search result for a movie may display a movie poster along with an icon identifying the result as a movie, and so on. The images may be clustered or otherwise displayed in groups according to numerous criteria. For example, search results may be displayed as images and grouped according to date, media type, search result source, etc.

A user may then select a result for viewing, listening, purchasing, etc. For example, if a user searches using the search phrase “Star Trek,” search results may include upcoming television episodes of Star Trek, upcoming Star Trek movies, recorded episodes of Star Trek, recorded Star Trek movies, photos of starships, Star Trek movies available for rental (e.g., from netflix), a Star Trek soundtrack available for purchase (e.g., from an online music store), etc. Each search result may have different controls associated with it, and may therefore be interactive in different ways.

Searches may be narrowed based on numerous criteria. For example, searches may be narrowed to just local or remote search results. Alternatively, or in addition, search results may be narrowed to include only video data, audio data, data associated with a particular date range (e.g., recordings made on a specified day), data gathered from a specific source, etc.

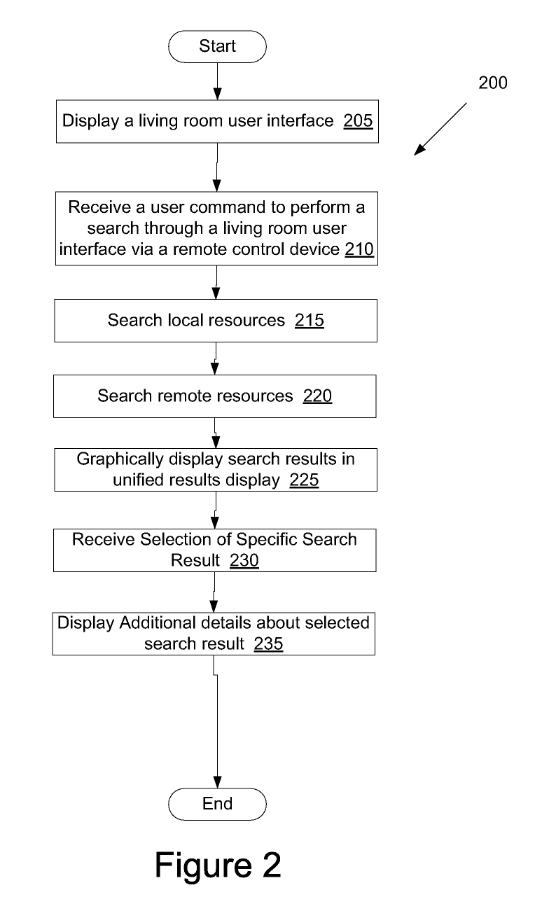

FIG. 2 illustrates a flow diagram for a method 200 of searching for media data. The method may be performed by processing logic that may comprise hardware (e.g., circuitry, dedicated logic, programmable logic, microcode, etc.), software (such as instructions run on a processing device), or a combination thereof. In one embodiment, method 200 is executable by the home media center 100 of FIG. 1. In a further embodiment, the method 200 may be initiated by a remote control device input from a living room user interface, and subsequently controlled by messages received from a remote control device.

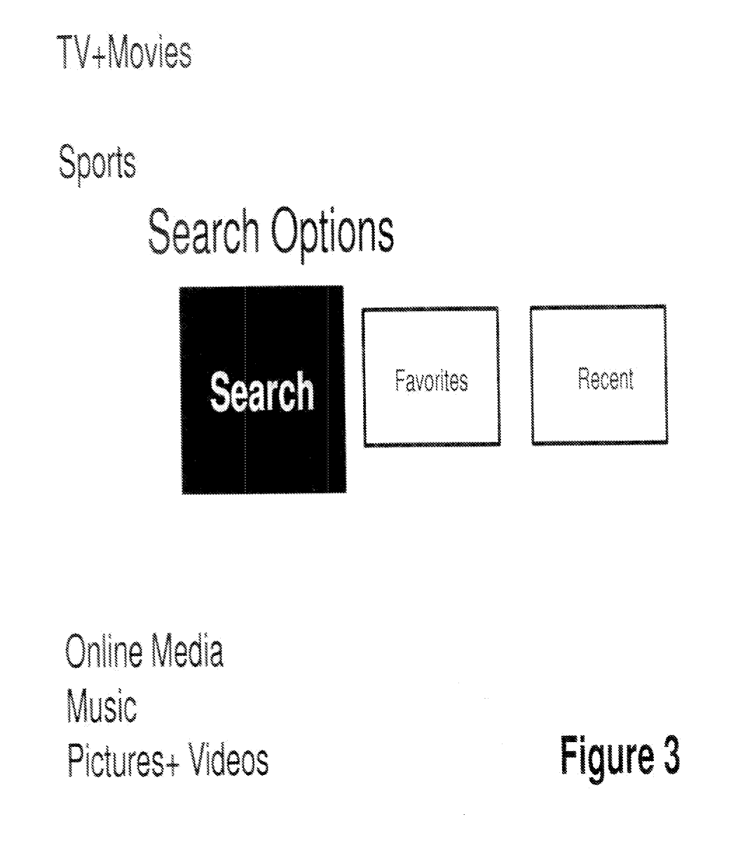

FIGS. 3-12 illustrate exemplary embodiments of a living room user interface in accordance with the present invention. FIGS. 3-12 are presented below with reference to FIG. 2 to illustrate embodiments of a user interface implemented in association with method 200.

Referring to FIG. 2, at block 205, a living room user interface is displayed. The living room user interface may include a display of multiple search options that are humanly viewable from a certain distance (e.g, from 5 ft., 10 ft., 20 ft., etc.). In one embodiment, the distance from which the living room user interface is viewable corresponds to an effective range of a remote control device. The viewable distance may be user selected by adjusting settings of the living room user interface.

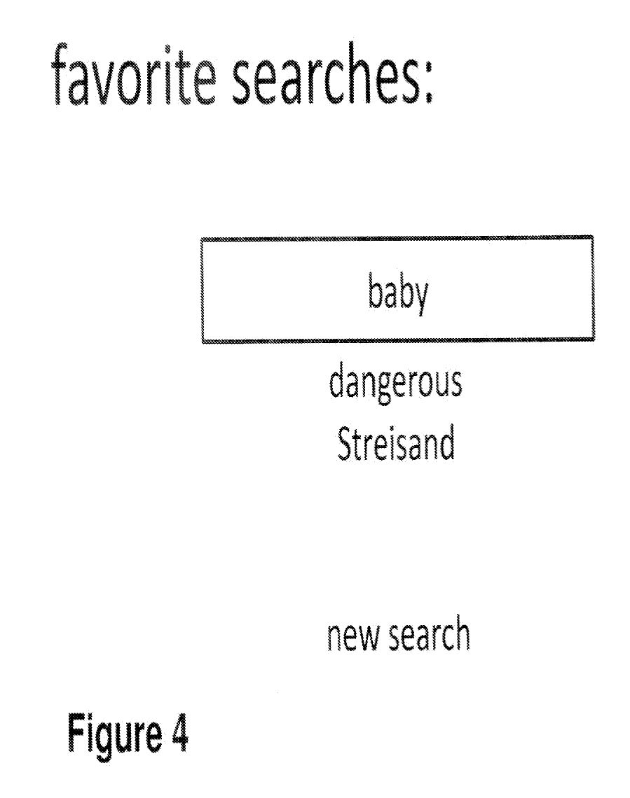

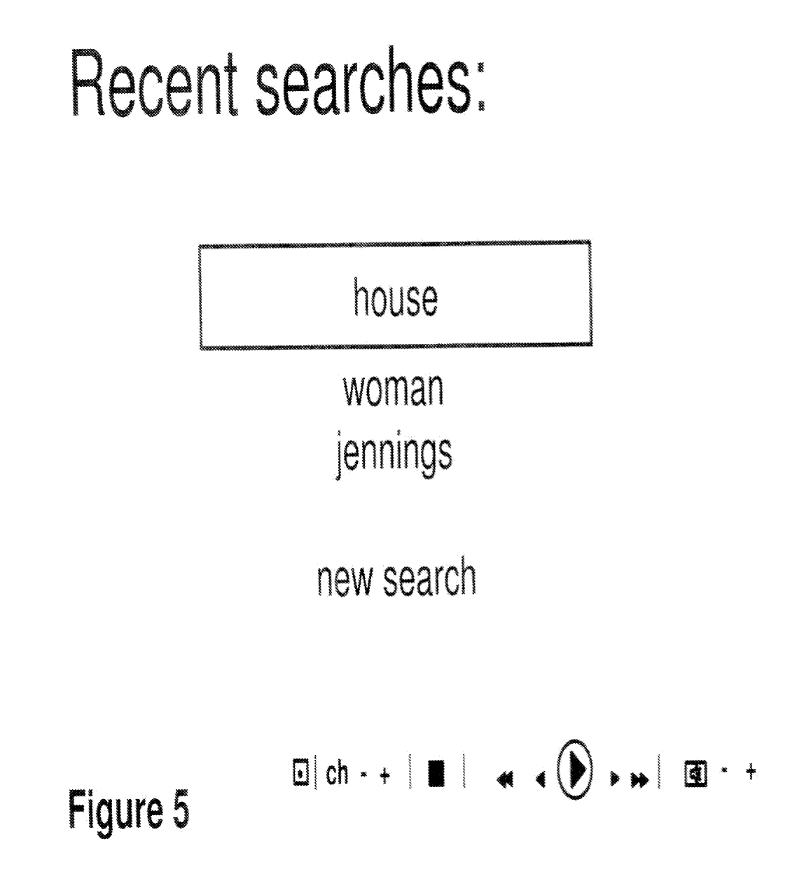

One example of a living room user interface showing multiple search options is illustrated in FIG. 3, which shows a standard search option, favorite searches option and recent searches option. FIG. 4 illustrates an exemplary display of favorite searches that may be shown if the favorite searches option is selected. The favorite searches may include those searches that are made most frequently, or searches that a user has specified as favorite searches. FIG. 5 illustrates an exemplary display of recent searches that may be shown if the recent searches option is selected. Recent searches may include searches made within a specified time period and/or a specified number or previous searches.

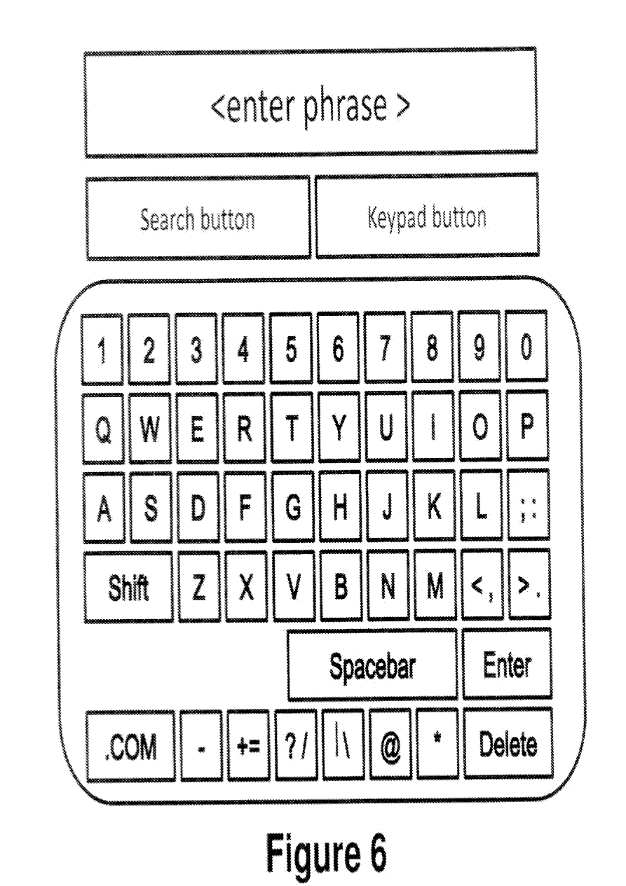

Returning to FIG. 2, at block 210, a user command is received through the living room user interface via a remote control device. The user command includes an input or selection of a search term. The command may be received via a keyboard, pointer, or other remote control device. If the search term is not received via a keyboard, a virtual keyboard may be used through which a user can select numbers and letters. FIG. 6 illustrates an exemplary virtual keypad through which search terms may be entered (e.g., a using triple-tap interface, pointer device, etc.).

Returning to FIG. 2, at block 215, local resources are searched. The local resources searched may depend upon a user selection of search agents. For example, a user may limit a search to only music files, or only to data available on an electronic programming guide (EPG). At block 220, remote resources are searched. The remote resources searched may also depend upon a user selection of search agents. For example, a user may limit a search to specific Internet services (e.g., movie rental service, online music store, online photo album, etc.).

At block 225 search results are graphically displayed in a unified results display. The unified results display may include results from multiple remote resources (e.g., internet services) and/or local resources. Graphically displaying the results includes displaying at least a portion of the results as images or a combination of text and images rather than simply as text. In one embodiment, graphically displayed results are displayed other than as a list of result names. Such graphically displayed results can be arranged according to various criteria such as date, media type, search result source, etc.

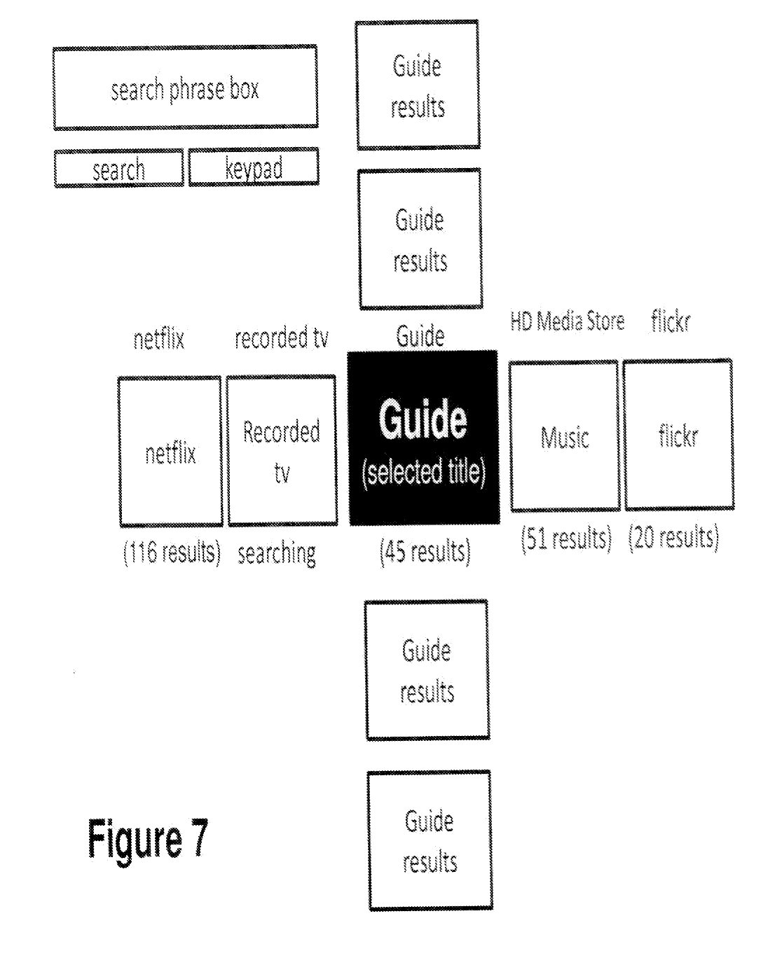

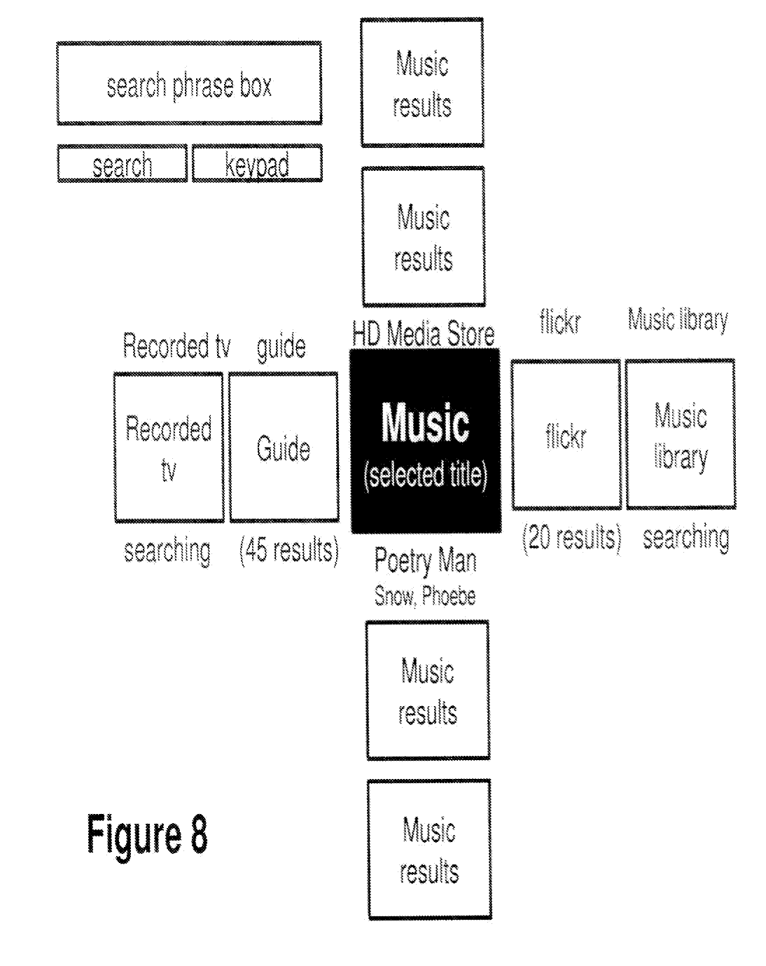

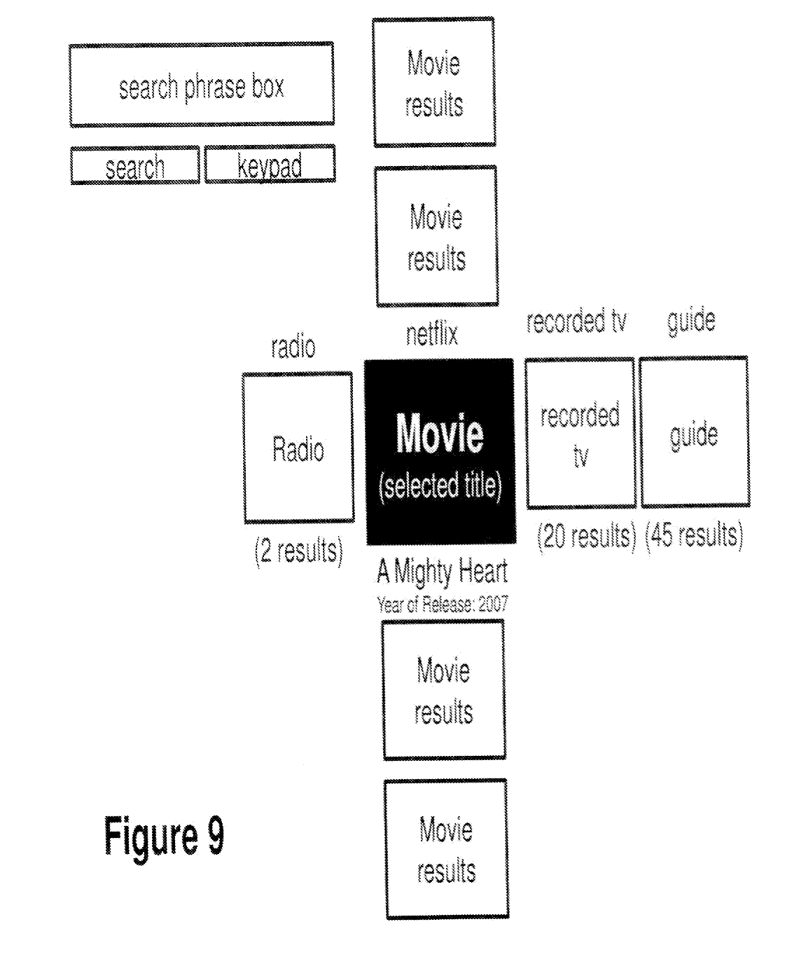

FIGS. 7-9 illustrate results from three exemplary searches. As shown, search results include results from an HD media store, from Flickr®, from a music library, from recorded TV, from Netflix®, and from the radio. In the illustrated embodiment of FIG. 7, results are divided by source. For example, a separate graphic is shown for each source that returned results, along with a number of results returned by that source. Selection of any one of the HD media store, Flickr®, music library, recorded TV, Netflix®, etc. can provide an expanded view of the search results related to the selected source. For example, in FIG. 8 HD media store is selected, causing search hits from the HD media store to be displayed. In FIG. 9, Netflix® is selected, causing search hits from Netflix® to be displayed. Exactly how search results are displayed may be user configurable.

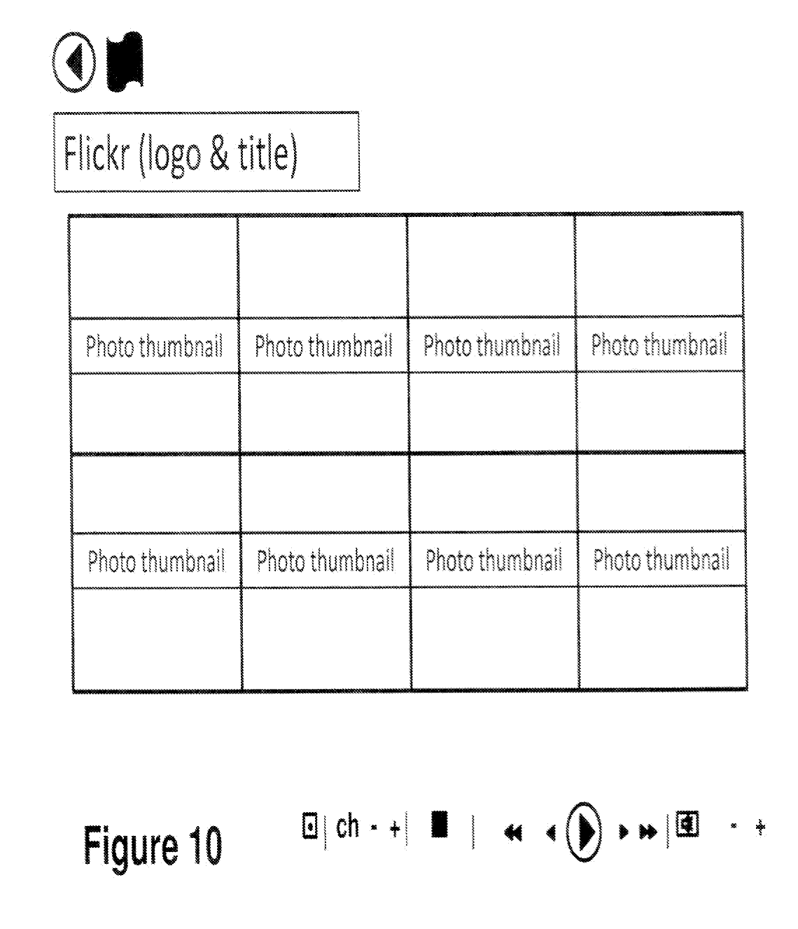

One or more sources or another subset of search results may be selected to show an expanded view of search results. The expanded view shows additional information pertaining to a selected subset of the search results. For example, FIG. 10 illustrates an expanded view of search results from Flickr®, in which movies matching the search term are shown. The additional information included in the expanded view may depend on the source or sources from which the search results were obtained and/or a type of electronic media included in the search results.

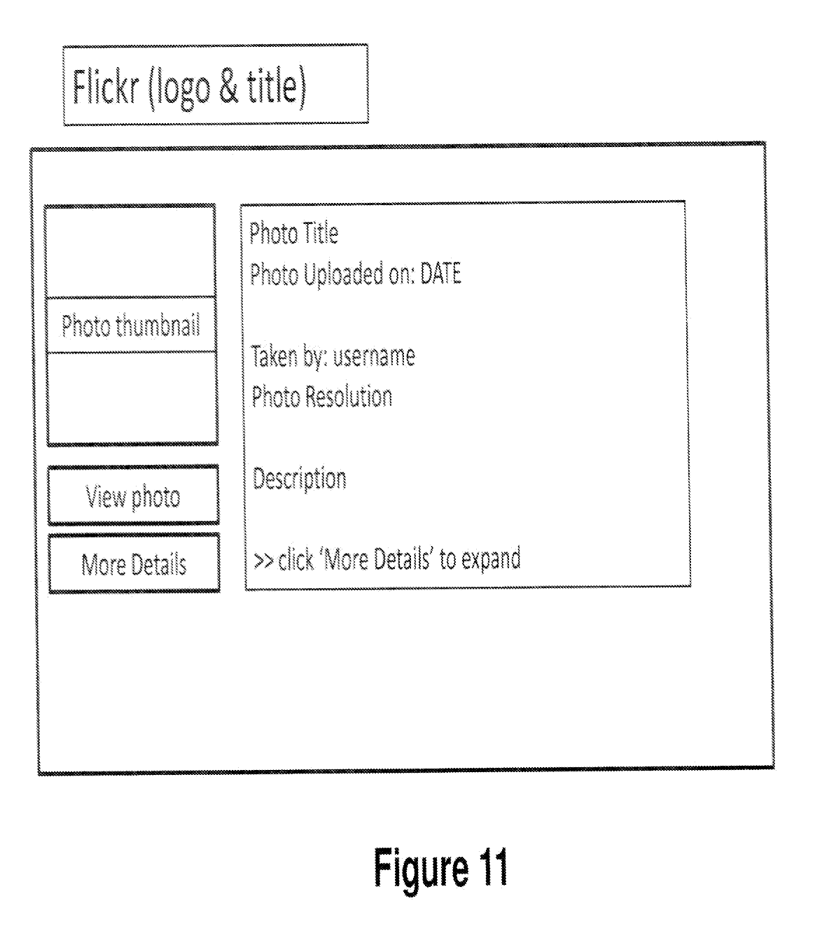

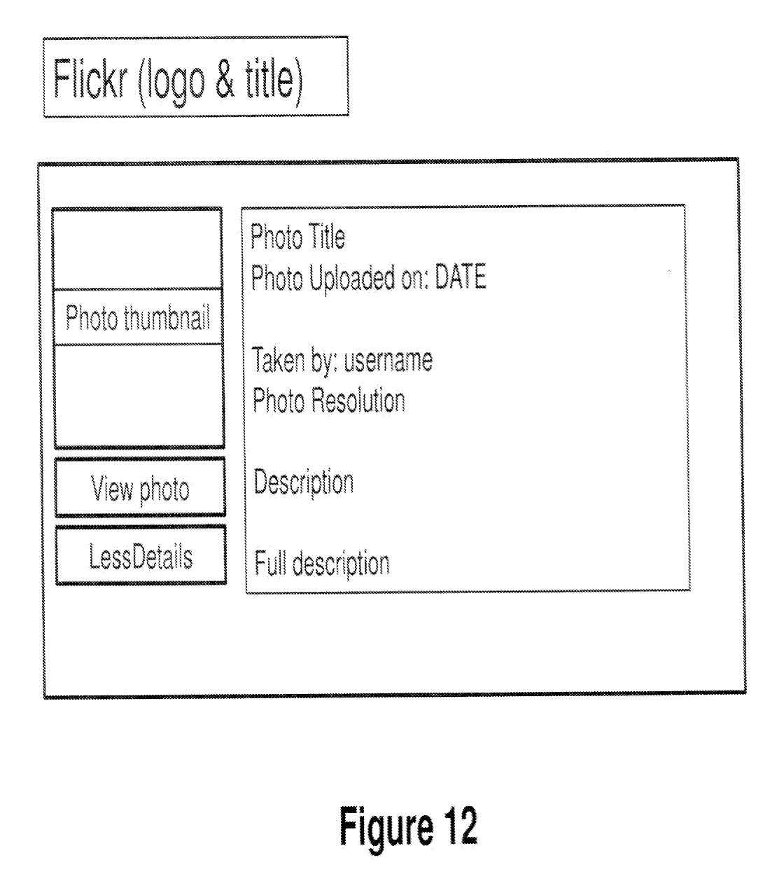

Returning to FIG. 2, at block 230 a selection of a specific search result is received. The selection may be received via a remote control, keyboard, etc. At block 235, additional details about the selected search result are displayed. The selected search result may then be viewed, listened to, added to a queue, purchased, etc. FIGS. 11-12 illustrate additional details about a selected search result from Flickr®.

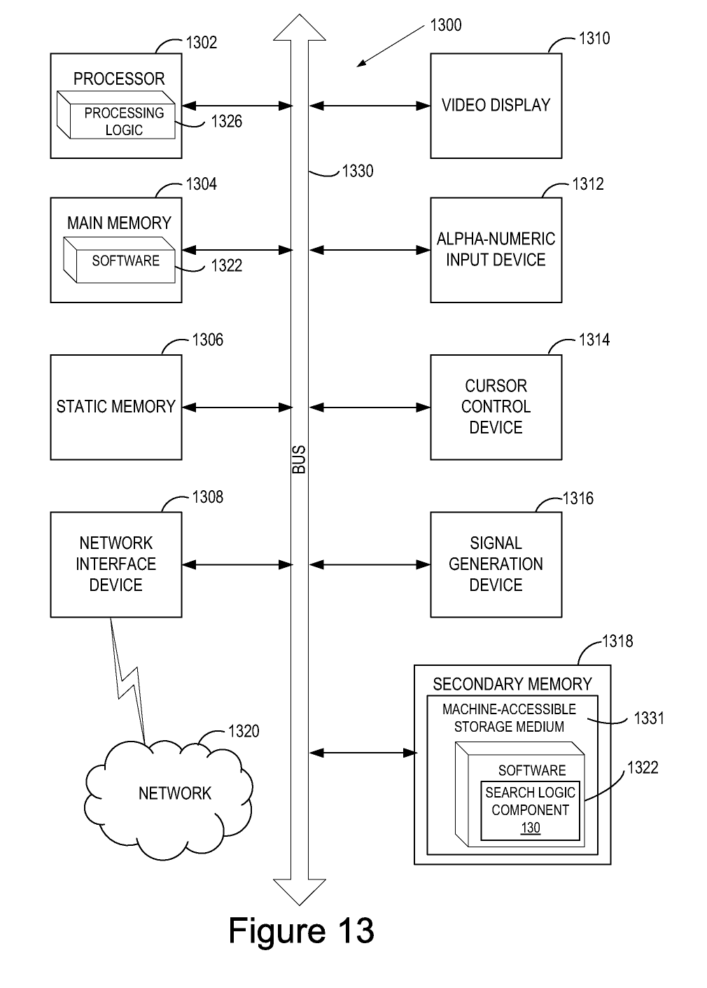

FIG. 13 illustrates a diagrammatic representation of a machine in the exemplary form of a computer system 1300 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1300 includes a processing device (processor) 1302, a main memory 1304 (e.g., read-only memory (ROM), flash memory, dynamic random access memory (DRAM) such as synchronous DRAM (SDRAM) or Rambus™ DRAM (RDRAM), etc.), a static memory 1306 (e.g., flash memory, static random access memory (SRAM), etc.), and a data storage device 418, which communicate with each other via a bus 1330.

Processor 1302 represents one or more general-purpose processing devices such as a microprocessor, central processing unit, or the like. More particularly, the processor 1302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1302 may also be one or more special-purpose processing devices such as an application specific integrated circuit (ASIC), a field programmable gate array (FPGA), a digital signal processor (DSP), network processor, or the like. The processor 1302 is configured to execute the processing logic 1326 for performing the operations and steps discussed herein.

The computer system 1300 may further include a network interface device 1308. The computer system 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse), and a signal generation device 1316 (e.g., a speaker).

The data storage device 1318 may include a machine-accessible storage medium 1331 on which is stored one or more sets of instructions (e.g., software 1322) embodying any one or more of the methodologies or functions described herein. The software 1322 may also reside, completely or at least partially, within the main memory 1304 and/or within the processor 1302 during execution thereof by the computer system 1300, the main memory 1304 and the processor 1302 also constituting machine-accessible storage media. The software 1322 may further be transmitted or received over a network 1320 via the network interface device 1308. In one embodiment, the software 1322 includes instructions for search logic component 130 of FIG. 1.

The machine-accessible storage medium 1331 may also be used to store data structure sets that define user identifying states and user preferences that define user profiles. Data structure sets and user profiles may also be stored in other sections of computer system 1300, such as static memory 1306.

While the machine-accessible storage medium 1331 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method, comprising:
receiving, by a computing device, a command to perform a search;
searching, by the computing device, a local resource for media items associated with a search term;
searching, by the computing device, an Internet service for additional media items associated with the search term using an application programming interface (API) associated with the Internet service;
consolidating local search results of the media items located on the local resource and remote search results of the additional media items provided by the Internet service; and
grouping the local search results and the remote search results into groups based on properties of the media items in the local search results and properties of the additional media items in the remote search results, wherein the groups are graphically displayable.

2. The method of claim 1, further comprising:
storing a login and a password associated with a user account of the Internet service; and
automatically logging into the Internet service using the stored login and password after receiving the search term to establish a session with the Internet service.

3. The method of claim 1, further comprising:
determining representative group images for the groups; and
graphically displaying the groups using the representative group images.

4. The method of claim 1, wherein the local resource comprises at least one of a first storage unit internal to the computing device or a second storage unit external to the computing device, the method further comprising:
receiving a user selection of at least one local resource or remote resource to exclude from searches, wherein the Internet service is a remote resource; and
searching local resources and remote resources other than the at least one local resource or remote resource.

5. The method of claim 1, wherein one or more of the media items and the additional media items include metadata that identifies the properties of the one or more of the media items and the additional media items, and wherein the metadata is usable to perform operations on subsets of the media items and the additional media items.

6. The method of claim 1, further comprising:
narrowing the search results based on at least one of the media type, the date or the search result source.

7. The method of claim 1, wherein the local search results and the remote search results are grouped into the groups based on at least one of media type, date or search result source.

8. A non-transitory computer readable storage medium including instructions that, when executed by a processing device, cause the processing device to perform a method comprising:
receiving, by a computing device, a command to perform a search;
searching, by the computing device, a local resource for media items associated with a search term;
searching, by the computing device, an Internet service for additional media items associated with the search term using an application programming interface (API) associated with the Internet service;
consolidating local search results of the media items located on the local resource and remote search results of the additional media items provided by the Internet service; and
grouping the local search results and the remote search results into groups based on properties of the media items in the local search results and properties of the additional media items in the remote search results, wherein the groups are graphically displayable.

9. The non-transitory computer readable storage medium of claim 8, the method further comprising:
generating a search query based on the search term;
adding the search query to a search queue; and
performing the searching of the local resource and of the Internet service in response to the search query advancing in the search queue.

10. The non-transitory computer readable storage medium of claim 8, the method further comprising:
receiving a user input of the search term or a user selection of the search term from a remote control device.

11. The non-transitory computer readable storage medium of claim 8, the method further comprising:
storing a login and a password associated with a user account of the Internet service; and
automatically logging into the Internet service using the stored login and password after receiving the search term to establish a session with the Internet service.

12. The non-transitory computer readable storage medium of claim 8, the method further comprising:
determining representative group images for the groups; and
graphically displaying the groups using the representative group images.

13. The non-transitory computer readable storage medium of claim 12, the method further comprising:
determining, for each group, a number of search results included in the group; and
displaying, for each group, a representative group image along with the determined number of search results.

14. The non-transitory computer readable storage medium of claim 8, wherein the local resource comprises at least one of a first storage unit internal to the computing device or a second storage unit external to the computing device, the method further comprising:
receiving a user selection of at least one local resource or remote resource to exclude from searches, wherein the Internet service is a remote resource; and
searching local resources and remote resources other than the at least one local resource or remote resource.

15. The non-transitory computer readable storage medium of claim 8, wherein one or more of the media items and the additional media items include metadata that identifies the properties of the one or more of the media items and the additional media items, and wherein the metadata is usable to perform operations on subsets of the media items and the additional media items.

16. The non-transitory computer readable storage medium of claim 8, the method further comprising narrowing the search results based on at least one of the media type, the date or the search result source.

17. The non-transitory computer readable storage medium of claim 8, wherein the local search results and the remote search results are grouped into the groups based on at least one of media type, date or search result source.

18. A computing device comprising:
a memory to store instructions for performing a unified media search; and
a processing device, coupled to the memory, to execute the instructions, wherein the instructions cause the processing device to perform the following in response to receiving a command to perform a search:
search a local resource for media items associated with a search term;
search an Internet service for additional media items associated with the search term using an application programming interface (API) associated with the Internet service;
consolidate local search results of the media items located on the local resource and remote search results of the additional media items provided by the Internet service;
group the local search results and the remote search results into groups based on properties of the media items in the local search results and properties of the additional media items in the remote search results; and
display the groups to a display device.

19. The computing device of claim 18, wherein the instructions further cause the processing device to
determine representative group images for the groups; and
graphically display the groups using the representative group images.

20. The computing device of claim 18, wherein the computing device is a home media center and the media items comprise one or more of audio data, video data, digital still images, electronic documents and spreadsheets.

21. The computing device of claim 18, wherein the instructions further cause the processing device to narrow the search results based on at least one of the media type, the date or the search result source.
